(19) United States
(12) Patent Application Publication
(10) Pub. No.: US 2015/0194241 A1
(43) Pub. Date: Jul. 9, 2015

(54) ELECTRICAL CONDUCTORS AND METHODS OF FORMING THEREOF

(71) Applicant: THE BOEING COMPANY, Seal Beach, CA (US)

(72) Inventor: Minas H. Tanielian, Bellevue, WA (US)

(73) Assignee: THE BOEING COMPANY, Seal Beach, CA (US)

(21) Appl. No.: 14/151,229

(22) Filed: Jan. 9, 2014

(51) Int. Cl. H01B 13/00; H01B 5/14; H01B 1/02

(52) U.S. Cl. CPC H01B 13/0026; H01B 1/02; H01B 5/14

(57) ABSTRACT

An electrical conductor is provided. The electrical conductor includes a graphite intercalation compound and at least one layer of electrically conductive material extending over at least a portion of the graphite intercalation compound. The graphite intercalation compound includes a carbon-based particle and a plurality of guest molecules intercalated in the carbon-based particle.

### BACKGROUND

The field of the present disclosure relates generally to electrical conductors, and more specifically, to electrical conductors formed at least partially from graphite intercalation compounds.

In at least some known applications, electrical power, current, and electrical/electronic signals are typically conducted through wires or cables. Generally, known electrical wires or cables include a conductor core and an insulative jacket disposed peripherally about the conductor core. At least some known conductor cores are fabricated from materials such as copper, silver, gold, and aluminum. While these known materials have desirable electrical conductivity, it is a continuing goal to reduce weight in many known applications by developing electrical conductors having reduced weight and at least comparable electrical conductivity to known metallic electrical conductors. For example, in the aerospace industry, reducing the weight of an aircraft typically results in increased fuel efficiency, and/or increased payload capacity.

At least one known attempt at developing electrical conductors having reduced weight and comparable electrical conductivity has included forming electrically conductive graphite intercalation compounds. Intercalation is the process of introducing guest molecules or atoms between graphene layers of graphitic carbon. More specifically, at least some known processes effectively introduce “dopant” guest molecules or atoms between the graphene layers via diffusion due to the relatively weak bond strength between adjacent graphene layers in graphitic carbon. While graphite intercalation compounds have desirable electrical conductivity and reduced weight when compared to metallic electrical conductors of similar size, graphite intercalation compounds are generally brittle and susceptible to exfoliation of the graphene layers when exposed to increased temperatures. Moreover, intercalating graphitic carbon with guest molecules or atoms generally only increases the in-plane electrical conductivity of the graphitic carbon, and reduces the electrical conductivity of the graphitic carbon normal to the planes.

### BRIEF DESCRIPTION

In one aspect of the disclosure, an electrical conductor is provided. The electrical conductor includes a graphite intercalation compound and at least one layer of electrically conductive material extending over at least a portion of the graphite intercalation compound. The graphite intercalation compound includes a carbon-based particle and a plurality of guest molecules intercalated in the carbon-based particle.

In another aspect of the disclosure, an electrical conductor is provided. The electrical conductor includes a base matrix of electrically conductive material and a plurality of graphite intercalation compounds dispersed in the base matrix. Each of the plurality of graphite intercalation compounds include a carbon-based particle and a plurality of guest molecules intercalated in the carbon-based particle.

In yet another aspect of the disclosure, a method of forming an electrical conductor is provided. The method includes providing a graphite intercalation compound that includes a carbon-based particle and a plurality of guest molecules intercalated in the carbon-based particle. The method also includes extending electrically conductive material over at least a portion of the graphite intercalation compound. The electrically conductive material is in the form of at least one layer of electrically conductive material or a base matrix of electrically conductive material.

### BRIEF DESCRIPTION OF THE DRAWINGS

FIG. 1 is a flow diagram of an exemplary aircraft production and service methodology.

FIG. 2 is a block diagram of an exemplary aircraft.

FIG. 3 is a schematic cross-sectional illustration of an exemplary electrical conductor.

FIG. 4 is a schematic illustration of an alternative electrical conductor.

FIG. 5 is a flow diagram illustrating an exemplary method of forming an electrical conductor.

### DETAILED DESCRIPTION

The implementations described herein relate to electrical conductors formed at least partially from graphite intercalation compounds (GICs). GICs are formed from carbon-based particles having a plurality of guest molecules intercalated therein. In the exemplary implementation, the GIC is then surrounded by an electrically conductive material to form the electrical conductors described herein. For example, the electrically conductive material may be in the form of either at least one layer or a base matrix of electrically conductive material. GICs can have about five times greater in-plane electrical conductivity and weigh about four times less than metallic electrical conductors of similar size, such as copper. As such, the electrical conductors described herein weigh less and have at least comparable electrical conductivity relative to similarly sized electrical conductors formed from known metallic, electrically conductive material.

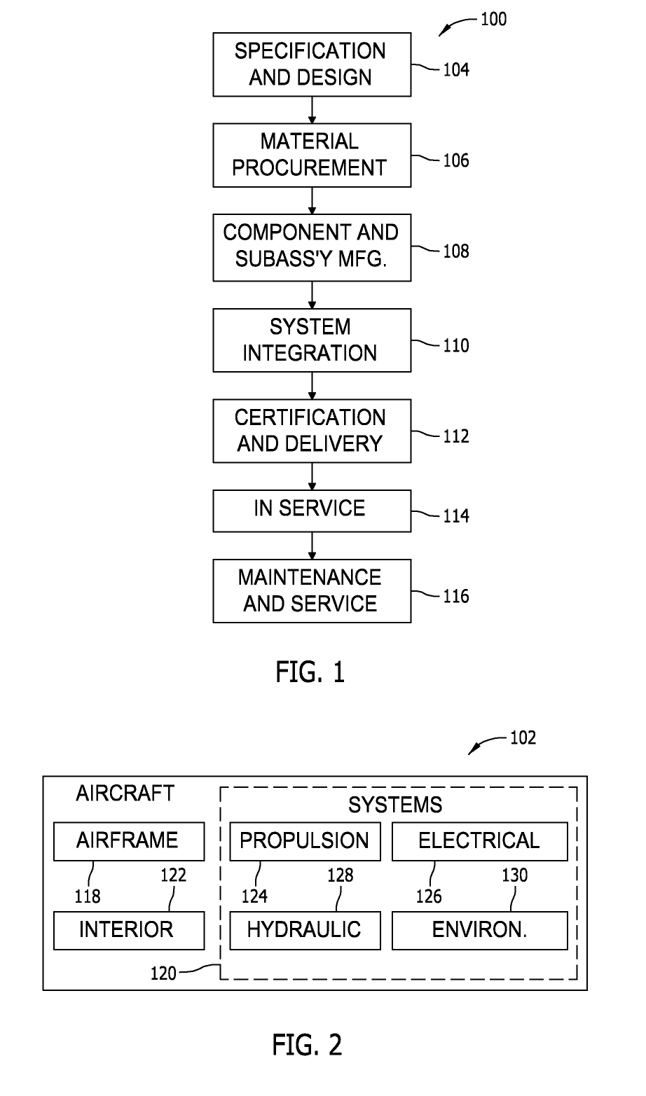

Referring to the drawings, implementations of the disclosure may be described in the context of an aircraft manufacturing and service method 100 (shown in FIG. 1) and via an aircraft 102 (shown in FIG. 2). During pre-production, including specification and design 104 data of aircraft 102 may be used during the manufacturing process and other materials associated with the airframe may be procured 106. During production, component and subassembly manufacturing 108 and system integration 110 of aircraft 102 occurs, prior to aircraft 102 entering its certification and delivery process 112. Upon successful satisfaction and completion of airframe certification, aircraft 102 may be placed in service 114. While in service by a customer, aircraft 102 is scheduled for periodic, routine, and scheduled maintenance and service 116, including any modification, reconfiguration, and/or refurbishment, for example. In alternative implementations, manufacturing and service method 100 may be implemented via vehicles other than an aircraft.

Each portion and process associated with aircraft manufacturing and/or service 100 may be performed or completed by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 2, aircraft 102 produced via method 100 may include an airframe 118 having a plurality of systems 120 and an interior 122. Examples of high-level systems 120 include one or more of a propulsion system 124, an electrical system 126, a hydraulic system 128, and/or an environmental system 130. Any number of other systems may be included.

Apparatus and methods embodied herein may be employed during any one or more of the stages of method 100. For example, components or subassemblies corresponding to component production process 108 may be fabricated or manufactured in a manner similar to components or subassemblies produced while aircraft 102 is in service. Also, one or more apparatus implementations, method implementations, or a combination thereof may be utilized during the production stages 108 and 110, for example, by substantially expediting assembly of, and/or reducing the cost of assembly of aircraft 102. Similarly, one or more of apparatus implementations, method implementations, or a combination thereof may be utilized while aircraft 102 is being serviced or maintained, for example, during scheduled maintenance and service 116.

As used herein, the term “aircraft” may include, but is not limited to only including, airplanes, unmanned aerial vehicles (UAVs), gliders, helicopters, and/or any other object that travels through airspace. Further, in an alternative implementation, the aircraft manufacturing and service method described herein may be used in any manufacturing and/or service operation.

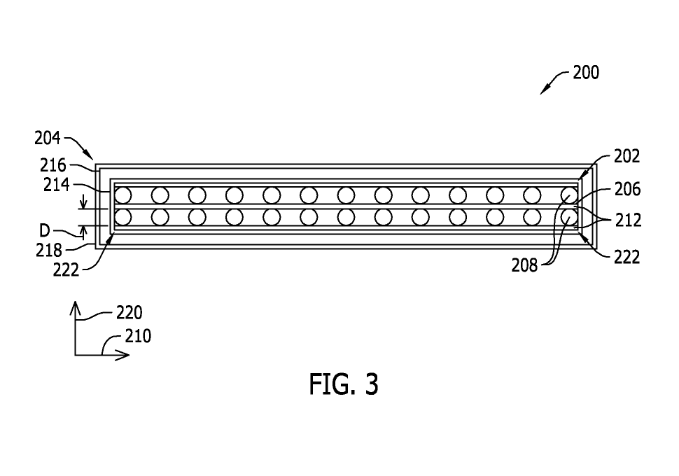

FIG. 3 is a schematic cross-sectional illustration of an exemplary electrical conductor 200. In the exemplary implementation, electrical conductor 200 includes a graphite intercalation compound (GIC) 202 and layers 204 of electrically conductive material extending over at least a portion of GIC 202. GIC 202 is formed from a carbon-based particle 206 and a plurality of guest molecules 208 intercalated in carbon-based particle 206. Carbon-based particle 206 may be in any shape that enables electrical conductor 200 to function as described herein. Exemplary shapes are selected from, but are not limited to flakes, platelets, fibers, spheres, tubes, and rods. Moreover, carbon-based particle 206 is fabricated from graphitic carbon, such as highly oriented pyrolytic graphite, including layers 212 of graphene extending in a substantially planar direction 210.

As described above, guest molecules 208 are intercalated in carbon-based particle 206. More specifically, guest molecules 208 are positioned between adjacent layers 212 of graphene of carbon-based particle 206. Guest molecules 208 are fabricated from any material that enables electrical conductor 200 to function as described herein. Exemplary materials include, but are not limited to, bromine, calcium, and potassium.

In the exemplary implementation, layers 204 of electrically conductive material include a first layer 214 of electrically conductive material, a second layer 216 of electrically conductive material, and a third layer 218 of electrically conductive material. First layer 214 extends over at least a portion of GIC 202, second layer 216 extends over at least a portion of first layer 214, and third layer 218 extends over at least a portion of second layer 216. Each of first, second, and third layers 214, 216, and 218 serve a different function. For example, in the exemplary implementation, first layer 214 facilitates adhering second layer 216 to GIC 202, second layer 216 is fabricated from electrically conductive material that may be less expensive than material used to form first and third layers 214 and 218, and third layer 218 facilitates protecting second layer 216 from oxidation and/or physical strain, for example. In an alternative implementation, electrical conductor 200 may include any number of layers 204 that enable electrical conductor 200 to function as described herein.

Each layer 204 may be fabricated from any material that enables electrical conductor 200 to function as described herein. In the exemplary implementation, each layer 204 is fabricated from different materials. Exemplary materials used to fabricate first layer 214 include, but are not limited to, chromium and titanium. Exemplary materials used to fabricate second layer 216 include, but are not limited to, copper, silver, gold, and aluminum. Exemplary materials used to fabricate third layer 218 include, but are not limited to, silver, gold, and aluminum. Layers 204 are applied over GIC 202 via any suitable process. Exemplary processes include, but are not limited to, sputtering, ion beam plating, electroplating, electroless plating, wet chemical, and vapor deposition.

In the exemplary implementation, layers 204 extend over GIC 202 such that guest molecules 208 are fully enclosed within carbon-based particle 206. More specifically, layers 204 extend over GIC 202 in both planar direction 210 and a normal direction 220 relative to planar direction 210 to encapsulate GIC 202 in an electrically conductive overlayer (not shown). In some implementations, extending layers 204 over GIC 202 in normal direction 220 facilitates increasing the electrical conductivity of electrical conductor 200 in normal direction 220. As described above, intercalating guest molecules 208 in carbon-based particle 206 generally only increases the electrical conductivity of GIC 202 in planar direction 210. More specifically, intercalating guest molecules 208 in carbon-based particle 206 increases a distance D between adjacent graphene layers 212. The electrical conductivity of carbon-based particle 206 in normal direction 220 is reduced as distance D increases. As such, in the exemplary implementation, layers 204 provide a low-resistance interconnection path between the high in-plane conductivity of a given GIC 202 to multiple GICs 202 to form an electrically conductive composite layer (not shown).

In some implementations, multiple electrical conductors 200 may be interconnected to facilitate forming an elongated electrical conductor (not shown). For example, multiple electrical conductors 200 may be physically, chemically, and/or electrochemically joined to facilitate forming the elongated electrical conductor. Because layers 204 are formed from electrically conductive material, interconnecting multiple electrical conductors 200 facilitates forming a substantially continuous electrical conductor.

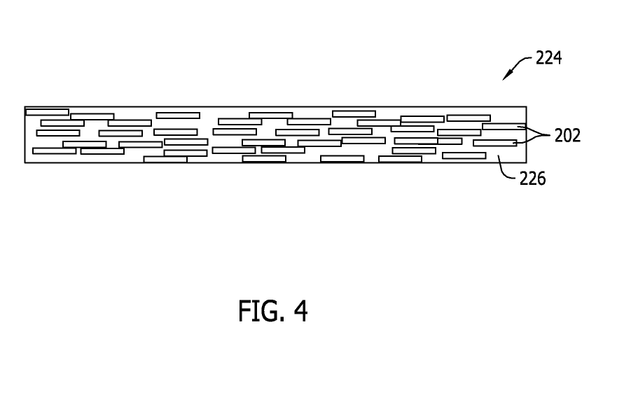

FIG. 4 is a schematic illustration of an alternative electrical conductor 224. In the exemplary implementation, electrical conductor 224 includes a base matrix 226 of electrically conductive material, and a plurality of GICs 202 dispersed in base matrix 226. Base matrix 226 is fabricated from any material that enables electrical conductor 224 to function as described herein. In the exemplary implementation, base matrix 226 is fabricated from a metallic material. As used herein, the term “metallic” may refer to a single metallic material or a metallic alloy material. Exemplary materials used to fabricate base matrix 226 include, but are not limited to, copper, silver, gold, and aluminum.

Because GICs 202 generally have a lower weight comparable or greater electrical conductivity than the material used to fabricate base matrix 226, dispersing GICs 202 in base matrix 226 forms electrical conductor 224 that weighs less than a similarly sized conventional electrical conductor formed only from the base matrix material. As such, the weight reduction is a function of a volume percentage of GICs 202 in electrical conductor 224. Any volume percentage of GICs 202 in electrical conductor 224 may be selected that enables electrical conductor 224 to function as described herein. In the exemplary implementation, the volume percentage of GICs 202 in electrical conductor 224 is up to about 70 percent of electrical conductor 224 by volume, which may result in at least about a 50 percent weight reduction of electrical conductor 224 when compared to conventional electrical conductors, such as copper.

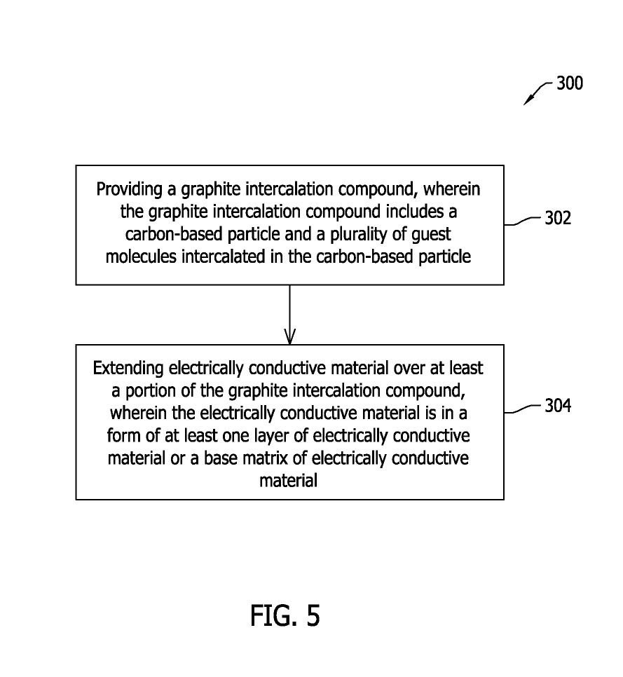

FIG. 5 is a flow diagram illustrating a method 300 of forming an electrical conductor, such as electrical conductor 200. Method 300 includes providing 302 a graphite intercalation compound, such as GIC 202, wherein the graphite intercalation compound includes a carbon-based particle, such as carbon-based particle 206, and a plurality of guest molecules, such as guest molecules 208, intercalated in the carbon-based particles. Method 300 also includes extending 304 electrically conductive material, such as layers 204 of electrically conductive material, over at least a portion of the graphite intercalation compound. The electrically conductive material is in a form of at least one layer of electrically conductive material or a base matrix, such as base matrix 226, of electrically conductive material.

The implementations described herein include electrical conductors having reduced weight and at least comparable electrical conductivity relative to purely metallic electrical conductors of similar size. More specifically, the electrical conductors described herein are at least partially formed from graphite intercalation compounds. As described above, graphite intercalation compounds can have about five times greater electrical conductivity and weigh about four times less than purely metallic electrical conductors, such as copper conductors. As such, the electrical conductors described herein weigh less and have at least comparable electrical conductivity relative to similarly sized electrical conductors formed from known metallic, electrically conductive material.

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electrical conductor comprising:
a graphite intercalation compound comprising:
a carbon-based particle; and
a plurality of guest molecules intercalated in said carbon-based particle; and
at least one layer of electrically conductive material extending over at least a portion of said graphite intercalation compound.

2. The electrical conductor in accordance with claim 1 further comprising a plurality of layers of electrically conductive material extending over at least the portion of said graphite intercalation compound, wherein each of said plurality of layers is fabricated from a different material.

3. The electrical conductor in accordance with claim 2, wherein said plurality of layers comprise an adhesion layer extending over at least the portion of said graphite intercalation compound, a conductive layer extending over at least a portion of said adhesion layer, and a protection layer extending over at least a portion of said conductive layer.

4. The electrical conductor in accordance with claim 1, wherein said at least one layer extends over said graphite intercalation compound such that said plurality of guest molecules are enclosed within said carbon-based particle.

5. The electrical conductor in accordance with claim 1, wherein said carbon-based particle is in a shape selected from flakes, platelets, fibers, spheres, tubes, and rods.

6. The electrical conductor in accordance with claim 1, wherein said carbon-based particle comprises graphitic carbon.

7. The electrical conductor in accordance with claim 6, wherein the graphitic carbon comprises a plurality of layers of graphene extending in a substantially planar direction, wherein said at least one layer of electrically conductive material encapsulates said plurality of layers of graphene.

8. The electrical conductor in accordance with claim 1, wherein said plurality of guest molecules are fabricated from at least one of bromine, calcium, and potassium.

9. The electrical conductor in accordance with claim 1, wherein said at least one layer of electrically conductive material is fabricated from at least one of copper, silver, gold, and aluminum.

10. An electrical conductor comprising:
a base matrix of electrically conductive material; and
a plurality of graphite intercalation compounds dispersed in said base matrix, wherein each of said plurality of graphite intercalation compounds comprise a carbon-based particle and a plurality of guest molecules intercalated in said carbon-based particle.

11. The electrical conductor in accordance with claim 10, wherein the plurality of graphite intercalation compounds comprise up to about 70 percent of the electrical conductor by volume.

12. The electrical conductor in accordance with claim 10, wherein said base matrix extends over said plurality of graphite intercalation compounds such that said plurality of guest molecules are enclosed within said carbon-based particle.

13. The electrical conductor in accordance with claim 10, wherein said carbon-based particle is in a shape selected from flakes, platelets, fibers, spheres, tubes, and rods.

14. The electrical conductor in accordance with claim 10, wherein said base matrix is fabricated from at least one of copper, silver, gold, and aluminum.

15. A method of forming an electrical conductor, said method comprising:
providing a graphite intercalation compound, wherein the graphite intercalation compound includes a carbon-based particle and a plurality of guest molecules intercalated in the carbon-based particle; and
extending electrically conductive material over at least a portion of the graphite intercalation compound, wherein the electrically conductive material is in a form of at least one layer of electrically conductive material or a base matrix of electrically conductive material.

16. The method in accordance with claim 15, wherein providing a graphite intercalation compound comprises forming the carbon-based particle from graphitic carbon including a plurality of graphene layers extending in a substantially planar direction, wherein the electrically conductive material encapsulates the plurality of graphene layers.

17. The method in accordance with claim 15, wherein providing a graphite intercalation compound comprises providing the carbon-based particle in a shape selected from flakes, platelets, fibers, spheres, tubes, and rods.

18. The method in accordance with claim 15, wherein extending electrically conductive material comprises extending electrically conductive material over the graphite intercalation compound such that the plurality of guest molecules are enclosed within the carbon-based particle.

19. The method in accordance with claim 15, wherein extending electrically conductive material comprises extending electrically conductive material over the graphite intercalation compound via at least one of sputtering, ion beam plating, electroplating, electroless plating, wet chemical, and vapor deposition processes.

20. The method in accordance with claim 15, wherein extending electrically conductive material comprises fabricating the electrically conductive material from at least one of copper, silver, gold, and aluminum.
